(19) United States
(12) Patent Application Publication
(10) Pub. No.: US 2009/0116579 A1
(43) Pub. Date: May 7, 2009

(54) INTERPROCESSOR COMMUNICATION LINK FOR A LOAD CONTROL SYSTEM

(76) Inventors: Arya Abraham, Bethlehem, PA (US); Brian Michael Courtney, Bethlehem, PA (US); Jonathan H. Ference, Fleetwood, PA (US); Kevin Kocher, Elkridge, MD (US); Jeremy Thomas Neyhart, Bethlehem, PA (US); Yash Shah, Center Valley, PA (US)

Correspondence Address: OSTROLENK FABER GERB & SOFFEN, 1180 AVENUE OF THE AMERICAS, NEW YORK, NY, 100368403, US

(21) Appl. No.: 11/938,039

(22) Filed: Nov. 9, 2007

Related U.S. Application Data
(60) Provisional application No. 60/985,037, filed on Nov. 2, 2007.

(51) Int. Cl. H04L 27/00

(52) U.S. Cl. 375/295; 315/76; 370/217

(57) ABSTRACT

The present invention provides a reliable communication protocol that provides multicasting of digital messages on an interprocessor link coupling together a plurality of processors of a load control system. Preferably, the load control system includes a plurality of sub-systems, with a number of the processors in each sub-system. The processors are each characterized by a unique individual address, while all of the processors of a single sub-system are characterized by an identical multicast address. The processors re-transmit digital messages on the communication link if a target address of the digital message is equal to the multicast address. The processors determine if acknowledgement messages are received from each of the processors from which acknowledgement messages were expected during a predetermined amount of time after transmitting an initial digital message, and transmit a retry message in response to determining that the acknowledgement messages were not received.

### RELATED APPLICATION

This application is based on and claims priority to U.S. Provisional Application Ser. No. 60/985,037, filed Nov. 2, 2007, entitled INTERPROCESSOR COMMUNICATION LINK FOR A LOAD CONTROL SYSTEM. The entire contents of which are hereby incorporated by reference.

### BACKGROUND OF THE INVENTION

1. Field of the Invention

The present invention relates to a load control system comprising a plurality of load control devices for controlling the amount of power delivered to a plurality of electrical loads from an AC power source, and more particularly, to a communication protocol for an interprocessor link providing for communication of digital messages between a plurality of processors of a lighting control system.

2. Description of the Related Art

Typical load control systems are operable to control the amount of power delivered to an electrical load, such as a lighting load or a motor load, from an alternating-current (AC) power source. A load control system generally comprises a plurality of control devices coupled to a communication link to allow for communication between the control devices. The control devices of a lighting control system include load control devices operable to control the amount of power delivered to the loads in response to digital messages received across the communication link or local inputs, such as user actuations of a button. Further, the control devices of a lighting control system often include one or more keypad controllers that transmit commands across the communication link in order to control the loads coupled to the load control devices. An example of a lighting control system is described in greater detail in commonly-assigned U.S. Pat. No. 6,803,728, issued Oct. 12, 2004, entitled SYSTEM FOR CONTROL OF DEVICES, which is incorporated herein by reference.

FIG. 1 is a simplified block diagram of a prior art lighting control system 10 according to the present invention. The lighting control system comprises a power panel 12 having a plurality of load control modules (LCMs) 14 (i.e., load control devices). Each load control module 14 is coupled to a lighting load 16 (or another type of electrical load, such as a motor load) for control of the amount of power delivered to the lighting load. Alternatively, each load control module 14 may be coupled to more than one lighting load 16, for example, four lighting loads, for individual control of the amount of power delivered to each of the lighting loads. The power panel 12 also comprises a module interface (MI) 18, which controls the operation of the load control modules 14 via digital signals transmitted across a power module control link 20

The lighting control system 10 further comprises a processor 22, which controls the operation of the lighting control system and thus the amount of power delivered to the lighting loads 16 by the load control modules 14. The processor 22 is operable to communicate with the module interface 18 of the power panel 12 via a power panel link 24. Accordingly, the module interface 18 is operable to cause the load control modules 14 to turn off and on and to control the intensity of the lighting loads 16 in response to digital messages received from the processor 22. The processor 22 is operable to be coupled to a plurality of power panels via the power panel link 24.

In addition to being coupled to the power panel link 24, the central processor 22 is also coupled to a control station link 26 for communication with a plurality of control stations 28 (i.e., wallstations or keypads). The control stations 28 allow users to provide inputs to the lighting control system 10. The processor 22 is operable to control the lighting loads 16 in response to digital messages received from the control stations 28.

The lighting control system 10 as shown in FIG. 1 further comprises a personal computer (PC) 30 and a second processor 32, which are all coupled together via an Ethernet link 34 using a standard Ethernet switch 36. The PC 30 executes a graphical user interface (GUI) software that allows a user of the lighting control system 10 to setup and monitor the lighting control system. The processors 22, 32 and the PC 30 are operable to communication on the Ethernet link 34 using an industry-standard Internet protocol, such as the Transmission Control Protocol (TCP) and the User Datagram Protocol (UDP).

However, these existing Internet protocols do not provide an ideal solution for communication between multiple processors 22, 32 of the lighting control system 10. For example, TCP provides for reliable, in-order delivery of digital messages, but does not allow for multicasting (i.e., broadcasting) of digital messages and results in high traffic on the Ethernet link 34 of digital messages that are transmitted to multiple control devices. In contrast, UDP provides for multicasting and broadcasting, but does not guarantee reliable delivery of digital messages. Thus, there is a need for a communication protocol for an Ethernet link of a load control system that offers reliable communications and allows for multicasting of digital messages.

### SUMMARY OF THE INVENTION

According to the present invention, a load control system comprises a plurality of control devices (e.g., processors) and a communication link (e.g., an interprocessor communication link) coupled to each of the control devices. Each of the control devices is characterized by a unique individual address (e.g., an individual processor address), while a subset (e.g., a sub-system) of the control devices are characterized by an identical multicast address (e.g., an sub-system multicast internet protocol address). Each of the control devices are operable to transmit an initial digital message having a target address (e.g., a target internet protocol address) on the communication link, re-transmit the initial digital message on the communication link only if the target address of the initial digital message is equal to the multicast address, and transmit an acknowledgement message in response to receiving the initial digital message. Each control device is further operable to determine if acknowledgement messages are received from each of the control devices from which acknowledgement messages are expected during a predetermined amount of time after transmitting the initial digital message, and transmit a retry message in response to determining that the acknowledgement messages were not received from each of the control devices from which acknowledgement messages were expected during the predetermined amount of time. Preferably, the first retry message comprises the initial digital message along with a bitmap having bits set to represent the control devices from which the first control device did not receive an acknowledgement message.

According to another embodiment of the present invention, a load control system comprises a plurality of sub-systems, a plurality of processors included in each of the sub-systems, and an interprocessor link coupling together the processors. Each of the processors are operable to transmit an initial digital message to all of the processors of a specific sub-system. Each processor is operable to transmit an acknowledgement message in response to receiving the initial digital message. Each processor is further operable to determine if acknowledgement messages are received from each of the processors from which acknowledgements messages were expected during a predetermined amount of time after transmitting the initial digital message, and transmit a retry message in response to determining that the acknowledgement messages were not received from each of the processors from which acknowledgements messages were expected during the predetermined amount of time.

The present invention further provides a method of communicating a digital message in a load control system having a plurality of control devices (including first, second, and third control devices) coupled together via a communication link. Each of the control devices is characterized by a unique individual address, and a subset of the control devices are characterized by an identical multicast address. The method comprises the steps of: (1) the first control device maintaining a list of the individual addresses of each of the control devices on the communication link; (2) the first control device transmitting an initial digital message on the communication link, the initial digital message including a target address; (3) the second control device receiving the initial digital message; (4) the second control device re-transmitting the initial digital message on the communication link if the target address of the initial digital message is equal to the multicast address of the control devices; (5) the second control device transmitting an acknowledgement message to the first control device in response to receiving the initial digital message; (6) the first control device waiting for a predetermined amount of time after the first control device transmitted the initial digital message to receive an acknowledgement message from the second and third control devices; (7) the first control device determining that an acknowledgment message was not received from the third control device; and (8) the first control device transmitting a first retry message after the end of the predetermined amount of time in response to determining that the first control device did not receive the acknowledgement message from the third control. Preferably, the first retry message comprises the initial digital message along with a bitmap having bits set to represent the control devices from which the first control device did not receive an acknowledgement message.

In addition, the present invention provides a processor for a load control system having a plurality of processors coupled together via a communication link, where each of the processors is characterized by a unique individual address, and a subset of the processors are characterized by an identical multicast address. The processor comprises a managed Ethernet switch adapted to be coupled to the communication link, a controller coupled to the managed Ethernet switch, and a memory coupled to the controller. The managed Ethernet switch is operable to store the multicast address and re-transmit a received digital message on the communication link if a target address of the received digital message is equal to the multicast address. The controller is operable to transmit an initial digital message on the communication link, and receive a plurality of acknowledgement messages in response to the initial digital message. The memory stores the individual addresses of at least one of the processors on the communication link. The controller is operable to determine if acknowledgement messages are received from each of the control devices having an individual address stored in the memory during a predetermined amount of time after transmitting the initial digital message, and transmit a retry message in response to determining that the acknowledgement messages were not received from each of the control devices having an individual address stored in the memory during the predetermined amount of time.

According to another aspect of the present invention, a method of communicating a digital message in a load control system having a plurality of control devices coupled together via a communication link comprises the steps of: (1) transmitting an initial digital message on the communication link; (2) determining that an acknowledgment message was not received from at least one of the control devices in response to the initial digital message; and (3) transmitting a retry message in response to determining that the acknowledgement message was not received from the at least one of the control devices, the retry message comprising the initial digital message along with data representative of the at least one control device from which the acknowledgement message was not received.

Other features and advantages of the present invention will become apparent from the following description of the invention that refers to the accompanying drawings.

### BRIEF DESCRIPTION OF THE DRAWINGS

FIG. 1 is a simplified block diagram of a prior art lighting control system;

FIG. 2 is a simplified block diagram of a load control system having multiple sub-systems and an interprocessor communication link according to the present invention;

FIG. 3 is a simplified block diagram of the load control system of FIG. 2 showing one of the sub-systems in greater detail;

FIG. 4 is a simplified block diagram of a processor of the load control system of FIG. 2;

FIG. 5A is a diagram showing the contents of command messages, event messages, and data messages of the interprocessor link of the load control system of FIG. 2;

FIG. 5B is a diagram showing the contents of acknowledgement messages of the interprocessor link of the load control system of FIG. 2;

FIG. 5C is a diagram showing the contents of acknowledgement with data messages of the interprocessor link of the load control system of FIG. 2;

FIG. 5D is a diagram showing the contents of retry messages of the interprocessor link of the load control system of FIG. 2;

FIG. 6 is a diagram of a header of each of the digital messages of FIGS. 5A-5D;

FIG. 7 is a simplified flowchart of a transmitting procedure executed periodically by the processor of FIG. 4; and

FIG. 8 is a simplified flowchart of a receiving procedure executed periodically by the processor of FIG. 4.

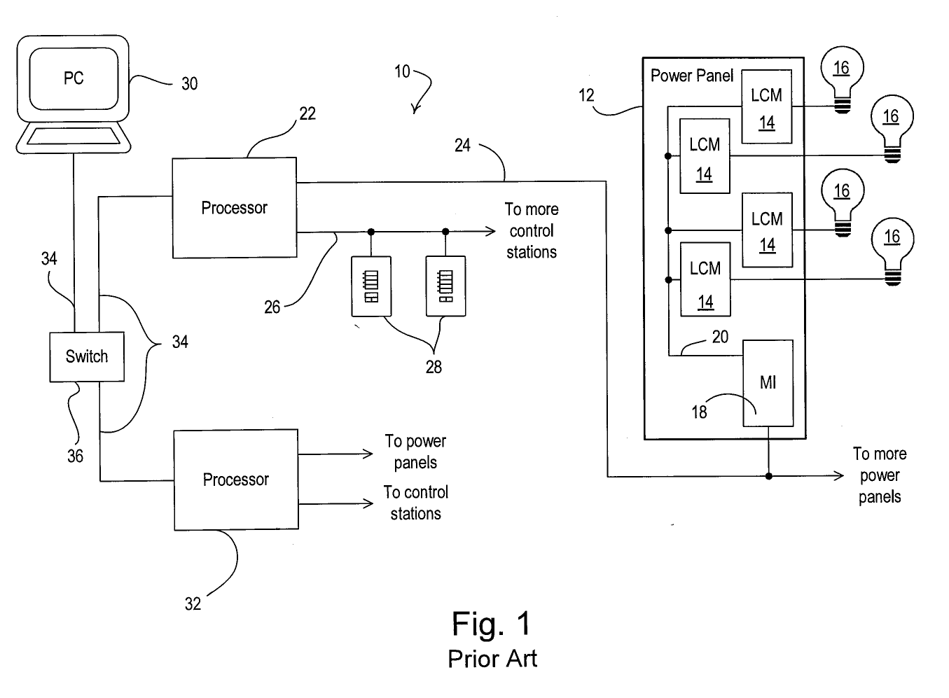

### DETAILED DESCRIPTION OF THE INVENTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

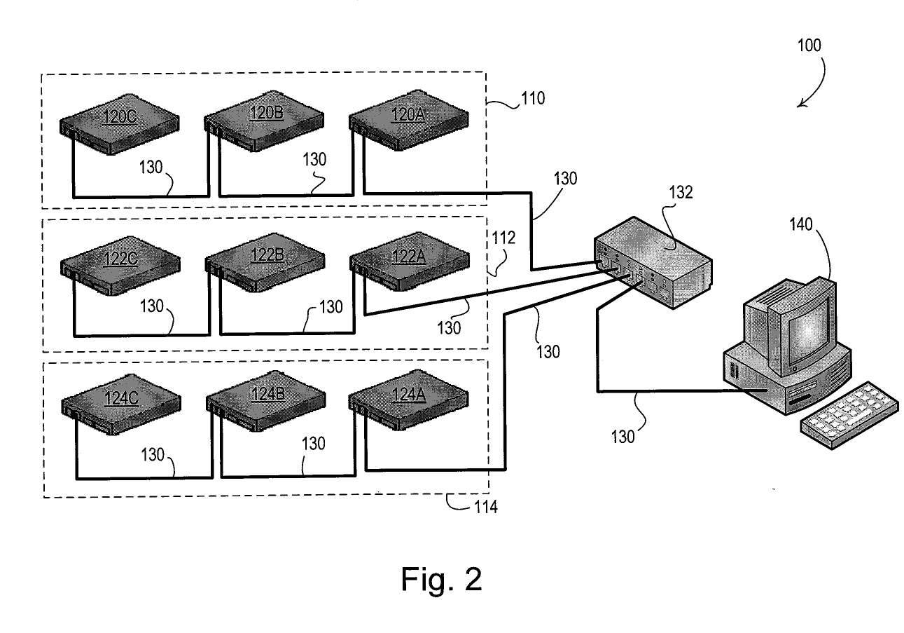

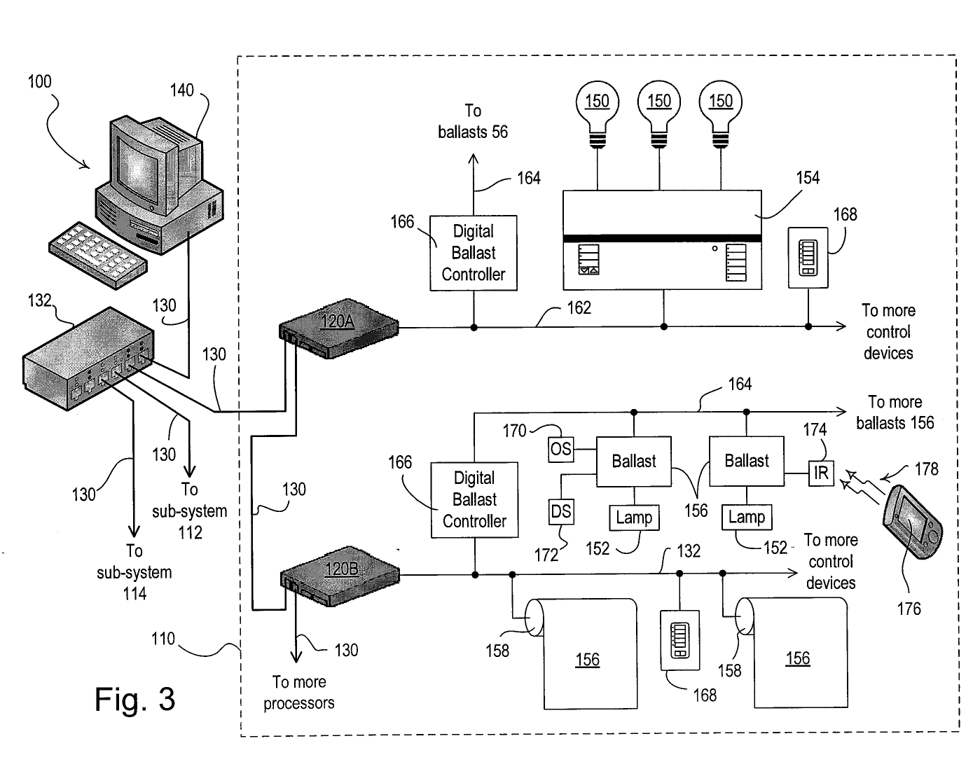

FIG. 2 is a simplified block diagram of a load control system 100 according to the present invention. The load control system 100 includes a plurality of sub-systems 110, 112, 114, which each comprise multiple control devices, i.e., processors 120A-120C, 122A-122C, 124A-124C. The sub-systems 110, 112, 114 form subsets of the processors 120A-124C. Each processor 120A-124C of the sub-systems 110, 112, 114 is coupled to a plurality of load control devices for controlling a plurality of electrical loads, such as, for example, lighting loads and motor loads, as will be described in greater detail below with reference to FIG. 3.

The processors 120A-124C are all coupled together via an interprocessor communication link 130, e.g., an Ethernet link, which allows the processors to communicate digital messages with each other. One of the processors 120A, 122A, 123A of each of the sub-systems 110, 112, 114 is coupled to an unmanaged Ethernet hub 132, i.e., an unmanaged Ethernet switch, to allow for communication between the sub-systems. The Ethernet hub 132 simply re-transmits any digital messages received on one portion of the interprocessor link 130 on the other portions of the interprocessor link. The load control system 100 also includes an application server 140, e.g., a PC, which executes a graphical user interface (GUI) software for allowing a user of the load control system 100 to configure, monitor, and control the operation of the load control system. The application server 140 is operable to transmit and receive digital messages with the processors 120A-124C of each of the sub-systems 110, 112, 114.

FIG. 3 is a simplified block diagram of the load control system 100 showing the first sub-system 110 in greater detail. The sub-system 110 is operable to control the level of illumination in a space by controlling the intensity level of the electrical lights in the space and the daylight entering the space. Specifically, the sub-system 110 is operable to control the amount of power delivered to a plurality of lighting loads, e.g., incandescent lamps 150 and fluorescent lamps 152. The sub-system 110 includes a multiple-zone lighting control device 154 (e.g., a GRAFIK Eye® Control Unit manufactured by Lutron Electronics Co., Inc.) for controlling the incandescent lamps 150, and digital electronic dimming ballasts 156 for controlling each of the fluorescent lamps 152. The sub-system 110 is further operable to control the position of a plurality of motorized window treatments, e.g., motorized roller shades 158, to control the amount of daylight entering the space. Each of the motorized roller shades 158 includes an electronic drive unit (EDU) 160, preferably located inside the roller tube of the associated roller shade.

The processors 120A, 120B are operable to communicate with the multiple-zone lighting control device 154 and the electronic drive units 160 via wired serial communication links 162, e.g., RS-485 digital communication links. The digital ballasts 156 are coupled to separate digital ballast communication links 164, e.g., Digital Addressable Lighting Interface (DALI) communication links, which are coupled to the wired serial communication links 162 via digital ballast controllers (DBC) 166. Each digital ballast controller 166 is operable to receive digital signals on the connected wired serial communication link 162 and to re-transmit the received digital signals on the connected digital ballast communication link 164 (and vice versa). The digital ballast controllers 166 also assist in the programming of the digital ballasts 156 during configuration of the load control system 100.

The sub-system 110 also includes wallstations 168, an occupancy sensor 170, a daylight sensor 172, and an infrared (IR) sensor 174. The infrared sensor 174 is operable to receive IR signals 178 from a handheld remote control 176, e.g., a personal digital assistant (PDA). As shown in FIG. 3, the wallstations 168 are coupled directly to the wired serial communication links 162, while the occupancy sensor 170, the daylight sensor 172, and the infrared sensor 174 are coupled to the ballasts 156. Preferably, the ballasts 156 are operable to transmit digital messages in response to inputs received from the occupancy sensor 170, the daylight sensor 172, and the infrared sensor 174. Accordingly, the multiple-zone lighting control device 154 and the ballasts 156 are operable to control the intensities of the connected lighting loads in response to digital messages originated from the wallstations 168, the occupancy sensor 170, the daylight sensor 172, and the infrared sensor 174. Further, the electronic drive units 160 are responsive to the digital messages from the wallstations 168, the occupancy sensor 170, the daylight sensor 172, and the infrared sensor 174 to open or close the motorized roller shades 158, adjust the position of the shade fabric of the roller shades, or set the roller shades to preset shade positions.

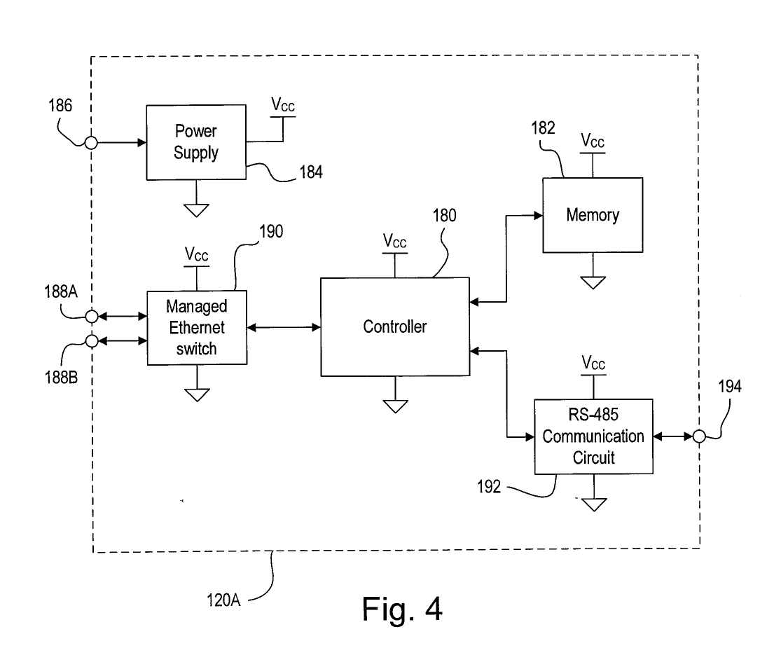

FIG. 4 is a simplified block diagram of one of the processors of the load control system 100, e.g., the processor 120A of the sub-system 110. While the structure of the processor 120A is described with reference to FIG. 4, each of the processors 120A-124C of the load control system 100 preferably have the same structure. The processor 120A comprises a controller 180, which may be any suitable controller, such as a microcontroller, a microprocessor, a programmable logic device (PLD), an application specific integrated circuit (ASIC), or a field programmable gate array (FPGA). Each processor 120A-124C is programmed with a Media Access Control (MAC) address during manufacturing of the processor. The controller 180 is coupled to a memory 182 (e.g., a non-volatile memory) for storage of the MAC address of the processor 120A and the programming information of the load control system 100. Alternatively, the memory may be included as an integral part of the controller 180. Further, the MAC address may alternatively be stored in the memory 182 by the manufacturer of the memory and simply installed in the processor 120A-124C during manufacturing of the processor.

The processor 120A also comprises a power supply 184, which receives, for example, a 24-volt DC voltage from an external power supply (not shown) at a voltage supply terminal 186. The power supply 184 generates a DC supply voltage V_{CC} (e.g., 5 V_{DC}) for powering the controller 180 and other low-voltage circuitry of the processor 120A. Alternatively, the power supply 184 may comprise an AC/DC power supply for receiving an AC voltage and generating a DC voltage for powering the controller 180.

The processor 120A has two physical Ethernet connections 188A, 188B to the interprocessor link 130 and a managed Ethernet switch 190 (e.g., part number KSZ8893MQL, manufactured by Micrel, Inc.) coupled between the two connections. The managed Ethernet switch 190 is operable to receive a digital message on one of the two connections to the interprocessor link 130 (e.g., the connection 188A), re-transmit the received digital message on the other connection (e.g., the connection 188B), and forward the received digital message to the controller 180, as will be described in greater detail below.

The controller 180 is also coupled to a communication circuit 192, e.g., an RS-485 transceiver, which is connected to one of the wired serial communication links of the sub-system 110. The controller 180 is operable to transmit digital messages on the wired serial communication link 162 in response to digital message received on the interprocessor link 130 (and vice versa).

The processors 120A-120C of the subsystem 110 are operable to communicate with each other by transmitting and receiving digital message across the interprocessor link 130 using an interprocessor link communication protocol. For example, the second processor 120B of the sub-system 110 is operable to transmit a digital message to the first processor 120A to control the intensities of incandescent lamps 152 connected to the multi-zone lighting control device 154 in response to an actuation of a button of the wallstation 168 connected to the second processor 120B.

According to the present invention, the interprocessor link protocol provides a robust communication protocol that allows for reliable delivery and multicasting of digital messages. The interprocessor link protocol is implemented as one of a number of protocol layers, which operate together to communicate the digital messages between the processors 120A-124C. The interprocessor link protocol layer is implemented on top of a lower-level transport layer, preferably, the industry-standard User Datagram Protocol (UDP), in addition to other protocol layers, such as, for example, the Transmission Control Protocol (TCP) layer and the Ethernet layer. The lower-level layers operate to translate the data from the interprocessor link protocol layer to a form that can be physically transmitted on the interprocessor link 130. Each processor 120A-124C of the load control system 100 is assigned a 32-bit Internet Protocol (IP) address, which is used by the lower-level layers to transport the digital messages between the processors. Each digital message transmitted using UDP includes a source IP address and a target IP address.

An application layer sits on top of the interprocessor link protocol layer and operates to determine what digital messages need to be transmitted across the interprocessor link 130 and what needs to be done with digital messages received via the interprocessor link 130.

Since the interprocessor link protocol layer is implemented on top of UDP, which supports multicasting and broadcasting, each processor 120A-120C of the first sub-system are operable to transmit a digital message to a single processor (e.g., the second processor 120B), and to broadcast a digital message to all of the processors of the first sub-system 110 or all of the processors 120A-124C in the load control system 100. Each of the processors 120A-120C of the first sub-system 100 is characterized by an identical sub-system multicast IP address such that the processors can broadcast digital messages to all of the other processors of the first sub-system. The processors 122A-122C of the second sub-system 112 and the processors 124A-124C of the third subsystem 114 have different sub-system multicast IP addresses than the processors 120A-120C of the first sub-system 110. In addition, each of the processors 120A-124C is characterized by a system broadcast IP address, which allows the any of the processors to transmit digital messages to all of the processors in the load control system 100.

The application server 140 includes the individual IP addresses of all of the processors 120A-124C, the sub-system multicast IP addresses of each of the sub-systems 110, 112, 114, and the system broadcast IP address of the load control system 100. Accordingly, the application server 140 is operable to transmit digital messages to the processors 120A, 120B, 120C via the interprocessor link 130 to control and configure the lighting loads and the motorized window treatments. The application server 140 also listens to all digital messages transmitted across the interprocessor link 130 and updates the GUI software to display the status of the load control system 100 on a display screen of the application server.

During configuration of the load control system 100, the application server 140 is operable to communicate with the processors 120A-124C using a configuration broadcast address, which is stored in every processor during manufacturing of the processor. The application server 140 uses the configuration broadcast address to discover the MAC addresses of all of the processors 120A-124C using an autodiscovery procedure, which is described in greater detail in co-pending commonly-assigned U.S. patent application Ser. No. 11/870,783, filed Oct. 11, 2007, entitled METHOD OF BUILDING A DATABASE OF A LIGHTING CONTROL SYSTEM, the entire disclosure of which is hereby incorporated by reference. The MAC addresses are then used to assign the IP addresses of the processors 120A-124C and the sub-system multicast IP addresses of the sub-systems 110, 112, 114.

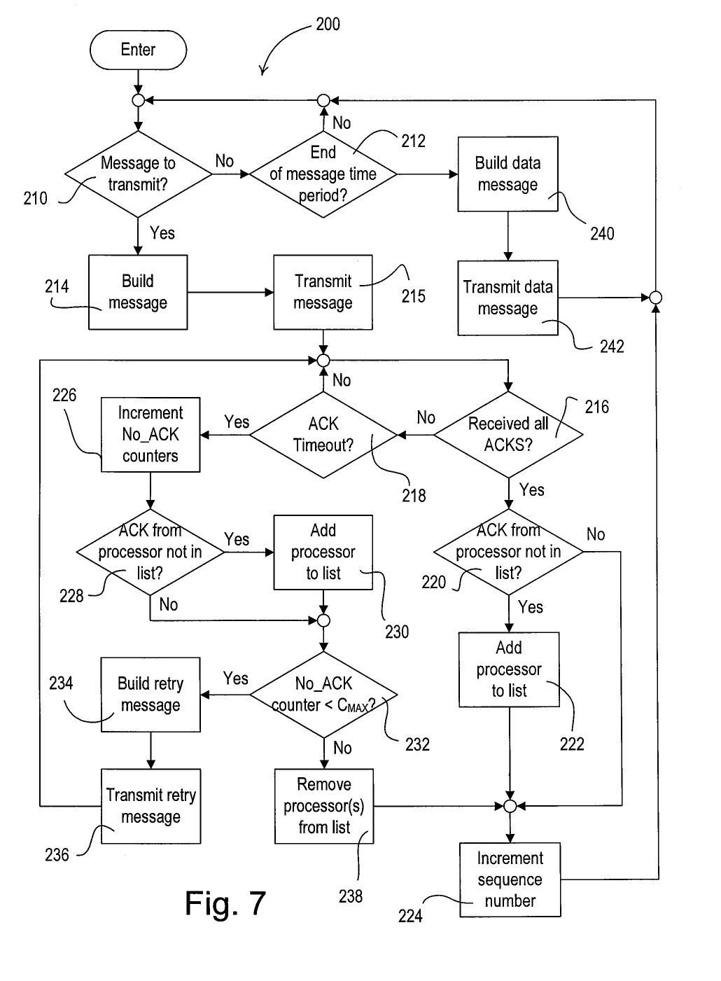

The managed Ethernet switch 190 of each of the processors 120A-124C includes an internal lookup table for storage of an IP address list of the individual IP addresses of each of the processors of its sub-system, the multicast IP address of its sub-system, and the system multicast IP address. The managed Ethernet switch 190 builds the IP address list of the individual IP addresses of the processors 120A-124C in response to the digital message transmitted across the interprocessor link, while the multicast IP address is directly assigned by the application server 140. Preferably, each of the processors 120A-124C is guaranteed to transmit at least one digital message within a predetermined message time period T_{MSG}, e.g., approximately every 30 seconds, as will be described in greater detail with reference to FIG. 7. When the managed Ethernet switch 190 receives a digital message having a target IP address that is equal to the sub-system multicast IP address stored in the internal lookup table, the managed Ethernet switch adds the source IP address of the received digital message to the IP address list (if the source IP address is not already stored in the IP address list).

When a digital message is received on one of the two connections to the interprocessor link 130 (e.g., the connection 188A), the managed Ethernet switch 190 re-transmits the digital message on the other connection (e.g., the connection 188A) only if the target IP address of the received digital message is any of the individual IP addresses, the sub-system multicast IP address, or the system broadcast IP address stored in the internal lookup table. Further, the managed Ethernet switch 190 only forwards a digital message to the controller 180 if the target address of the digital message is the individual IP address of the specific processor in which the managed Ethernet switch is located, or one of the sub-system multicast IP address, or the system broadcast IP address from the internal lookup table.

Preferably, only one of the processors 120A, 122A, 124A of each of the sub-systems 110, 112, 114 is connected to the Ethernet hub 132, such that the processor is operable to provide address filtering of the digital signals received from the Ethernet hub. The address filtering prevents digital messages having a target IP address that is not one of the individual IP addresses of the processors of the sub-system, the sub-system multicast IP address of the sub-system, or the system broadcast IP address from being transmitted to the other processors of the sub-system, thus minimizing the number of transmissions in each sub-system. For example, if the processor 120A receives a digital message having a target IP address that is not one of the individual IP addresses of the processors 120B, 120C, the multicast IP address of the sub-system 110, or the broadcast IP address of the load control system 100, then the processor simply does not re-transmit the digital message.

In addition to the 32-bit IP addresses used by the transport layer, the processors 120A-124C of the load control system 100 are also characterized by 8-bit processor (PROC) addresses. Specifically, each processor 120A-124C stores an 8-bit individual PROC address, an 8-bit sub-system multicast PROC address, and an 8-bit system broadcast PROC address. The application server 140 uses the 32-bit IP addresses of each of the processors 120A-124C to assign the various 8-bit PROC addresses to the processors 120A-124C. The individual PROC addresses may range, for example, from 0-127, such that each processor 120A-124C is assigned a unique individual PROC address. All of the processors 120A-120C of the first sub-system 110 are assigned an identical multicast PROC address, while the processors 122A-122C of the second sub-system 112 and the processors 124A-124C of the third sub-system 114 are assigned respective second and third multicast PROC addresses. Since the digital messages intended for different sub-systems are filtered using the 32-bit IP addresses (as described above) of the processors 120A-124C, the processors of each of the sub-systems 110, 112, 114 are preferably all assigned the same multicast PROC address, e.g., 255 (i.e., 0xFF). Finally, all of the processors 120A-124C of the load control system 100 are assigned an identical system broadcast PROC address.

Since UDP does not provide for guaranteed delivery of the digital messages, the interprocessor link protocol includes provisions to allow the processors 120A-120C to transmit acknowledgement (ACK) messages in response to receiving digital messages. Each of the processors 120A-120C maintains a list in memory of the individual PROC addresses of all of the processors in its sub-system 110, 112, 114 (i.e., a processor list). Similar to the managed Ethernet switch 190, the controller 180 of each of the processors 120A-124C builds the processor list in response to the received digital messages. If any of the processors 120A-124C receive a digital message from a processor whose individual address is not included in the processor list, the processor that received the digital message adds the individual address of the newly-found processor into the processor list.

If a first processor transmits an initial digital message using a multicast PROC address and does not receive acknowledgement messages from all of the processors having individual PROC addresses in the processor list in the memory 182, the first processor transmits a retry message. Preferably, only those processors from which the first processor did not receive an acknowledgement message transmit acknowledgement messages in response to the retry message. Specifically, each retry message includes an ACK bitmap, which is representative of the processors from which the first processor did not receive acknowledgement messages and need to transmit acknowledgement messages in response to the retry message. If a processor receives a retry message, but has already processed the initial digital message, the processor does not process the retry message independent of whether the processor needs to transmit an acknowledgement message in response to the retry message.

Further, the processors are operable to update the processor lists of individual PROC addresses in response to the digital messages transmitted on the interprocessor link 130. If a first processor transmits an initial digital message and a predetermined number of retry messages (e.g., two retry messages) to a second processor and does not receive any acknowledgement messages from the second processor, the first processor is operable to remove the individual PROC address of the second processor from the processor list stored in the memory 182 to that the first processor no longer expects to receive acknowledgement message from the second processor. If the first processor receives a digital message from a third processor, which has a individual PROC address that is not in the processor list in the memory 182, the first processor is operable to add the individual PROC address of the third processor to the processor list.

When a processor 120A-124C transmits a command or event message, the processor does not transmit any new command, event, or data messages until the processor either receives all of the acknowledgement messages or transmits the predetermined number of retry messages (i.e., two retry messages). Accordingly, each processor 120A-124C only deals with only one transmitted command, event, or data message at a time, which ensures that the processor has finished processing the digital message before moving onto the next digital message. Each processor 120A-124C maintains a sequence number, which is included with each new command, event, and data message and is incremented when each new command, event, or data message is transmitted by the processor.

The interprocessor link protocol supports different types of digital messages: command messages, event messages, data messages, acknowledgement messages, acknowledgement with data messages, and retry messages. Command messages are transmitted to cause the receiver to perform an action (e.g., controlling the intensity of the connected lighting load to a desired light intensity). Event messages are transmitted in response to inputs to the load control system 100 (e.g., an actuation of a button of a wallstation 168 or a change of state of an occupancy sensor). Data messages are transmitted to provides updates of system information (e.g., present light intensity, daylight sensor reading, etc.) to the other processors 120A-124C and the application server 140. Acknowledgement messages are only transmitted in response to receiving a command or an event message. Acknowledgement messages may include data (i.e., acknowledgement with data messages) if the acknowledgement message is being transmitted in response to a command message that is a request for data. Retry messages are transmitted if acknowledgement messages are not received from all processors in the sub-system. Additionally, the interprocessor protocol could include other types of digital messages.

Preferably, all command, event, data, and retry messages transmitted by the processors 120A-124C having target IP addresses equal to the multicast IP address of the sub-system 110, 112, 114 in which the transmitting processor is located. However, each acknowledgement message and acknowledgement with data message is transmitted having the target IP address equal to the individual IP address that was included as the source IP address of the received command, event, data, or retry message. For example, the managed Ethernet switch 190 of the first processor 120A only forwards an acknowledgement message to the controller 180 if the target IP address of the acknowledgement message is equal to the individual IP address of the first processor. Accordingly, acknowledgement messages and acknowledgement with data messages are only processed by the controllers 180 that need to receive the acknowledgement messages.

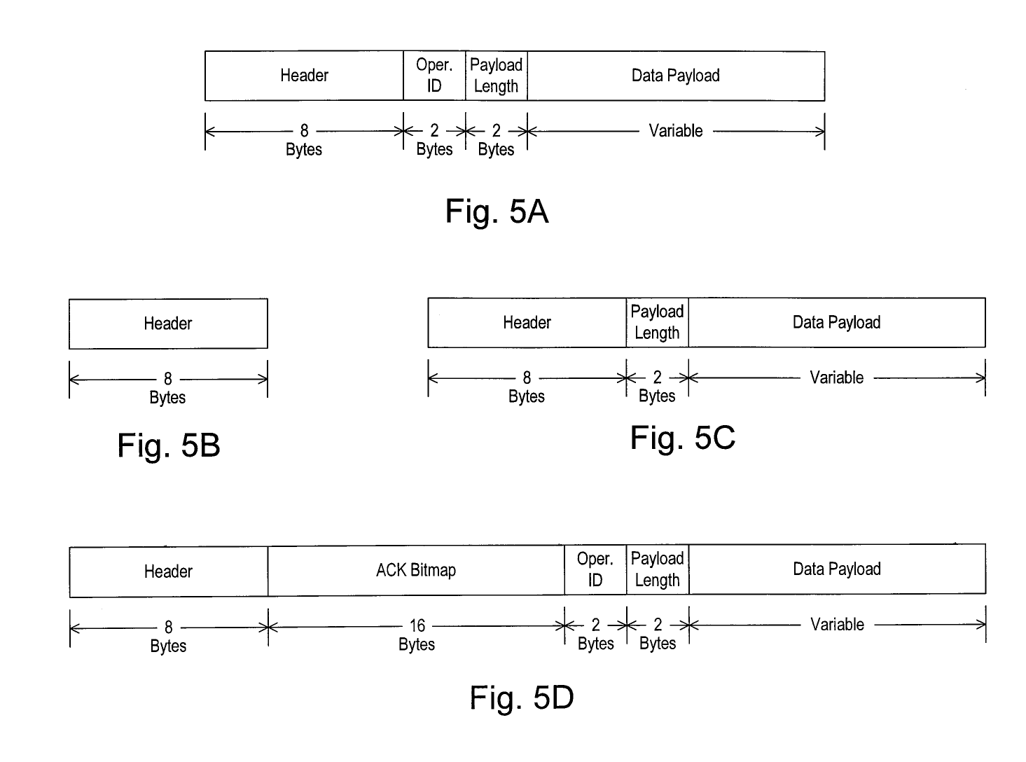

FIG. 5A is a diagram showing the contents of the command messages, the event messages, and the data messages. FIGS. 5B and 5C are diagrams showing the contents of the acknowledgement messages and the acknowledgement with data messages, respectively. FIG. 5D is a diagram showing the contents of the retry messages, which will be described in greater detail below.

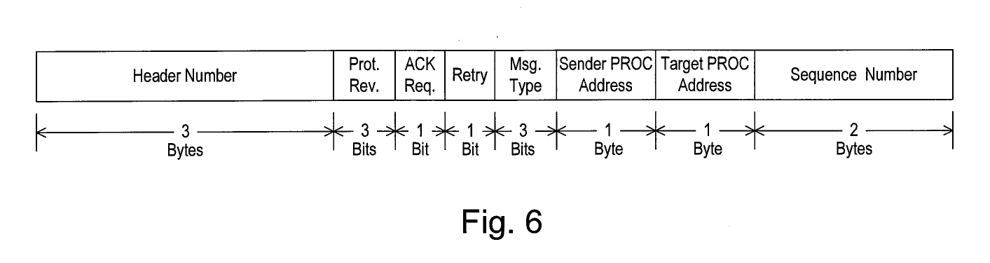

Each command, event, or data message begins with an eight-byte header, which is shown in FIG. 6. The header is followed by a two-byte operation ID. For example, the operation ID may specify what type of command is contained in a command message, such as, a “go to preset” command, or “request for data” command. After the operation ID is a two-byte payload length, which specifies the number of bytes included in a variable-length data payload that follows the payload length. The data payload includes specific values corresponding to the command (e.g., which preset to go to) or the requested data (i.e., in response to a “request for data” command). Acknowledgement messages simply comprise the eight-byte header, such that the acknowledgement messages can be quickly transmitted across the interprocessor link 130. Acknowledgement with data messages include the header, the payload length, and the data payload. Retry messages include the ACK bitmap, which specifies which of the processors 120A-124C of the load control system 100 should transmit acknowledgement messages in response to receiving the retry message.

FIG. 6 is a diagram of the header of each of the digital message transmitted across the interprocessor link 130. The header begins with a header number, which is an identical three-byte number that is included at the beginning of every digital message transmitted by the processors 120A-124C of the load control system 100 and is followed by a three-bit protocol revision. Next, the header includes two flags: an acknowledgement requirement flag and a retry flag. If the acknowledgement requirement flag is set, an acknowledgement message must be transmitted in response to receiving the digital message. If the acknowledgement requirement flag is not set, an acknowledgement message should not be transmitted in response to the digital message. If the retry flag is not set, the present digital message is an initial transmission of a specific command, event, or data digital message. However, if the retry flag is set, the present digital message is a retry message (as shown in FIG. 5D). After the flags, the header includes a three-bit message type, which specifies whether the present message is a command message, an event message, a data message, an acknowledgement message, or an acknowledgement with data message.

Next, the header includes an 8-bit sender PROC address (i.e., the individual PROC address of the processor 120A-124C that is transmitting the digital message) and an 8-bit target PROC address. The target PROC address may comprise the individual PROC address of one of the processors 120A-124C, the sub-system multicast PROC address of one of the sub-systems 110, 112, 114, or the system broadcast PROC address of the entire load control system 100. Finally, the header includes the two-byte sequence number, which is different for each new initial transmission of a command, event, or data message by one of the processors 120A-124C. The acknowledgement messages include the sequence number of the command or event message for which the acknowledgement message is being transmitted. The retry messages include the sequence number of the initial command or event message.

FIG. 7 is a simplified flowchart of a transmitting procedure 200 executed by the controller 318 of each processor 120A-124C in a cyclic fashion. The controller 180 first waits until the controller has a digital message to transmit at step 210 or until the message time period T_{MSG} (i.e., approximately 30 seconds since the last digital message was transmitted) expires at step 212. When the controller 180 has a digital message to transmit at step 210, the controller builds the digital message at step 214 and transmits the digital message on the interprocessor link 130 at step 215. For example, if the controller 180 has a “go to preset” command to transmit, the controller constructs at step 214 a digital message (as shown in FIG. 5A) with a header (as shown in FIG. 6) by setting the operation ID to that of a “go to preset” command and including the appropriate preset in the data payload. Further, the controller 180 uses the sub-system multicast PROC address as the target PROC address, sets the message type as a command message, and sets the ACK requirement flag, but does not set the retry flag of the header.

Next, the controller 180 waits to receive acknowledgment messages from all of the processors having an individual PROC address in the processor list stored in the memory 182 at step 216, or until a timeout (e.g., 400 msec) expires at step 218. If the controller 180 receives acknowledgment messages from all of the processors having individual PROC addresses in the processor list in the memory 182 at step 216, the controller determines at step 220 as to whether any acknowledgement messages were received from processors that have an individual PROC address that is not presently in the processor list at step 220. If so, the controller 180 adds the individual PROC address of the newly-found processor to the processor list at step 222. Since all of the expected acknowledgment messages were received at step 216, the controller 180 increments its sequence number at step 224 and the transmitting procedure 200 loops around to wait for the next digital message to transmit at step 210.

If the timeout expires at step 218 before the controller 180 receives acknowledgement messages from all of the processors at step 216, the controller increments a No_ACK counter at step 226 for each of the processors from which acknowledgement messages were not received. If the controller 180 received an acknowledgement message from any processors having an individual PROC address presently not in the processor list at step 228, the controller adds the individual PROC address of the new processor to the processor list at step 230.

If the No_ACK counters of the processors from which acknowledgement messages were not received are less than a maximum counter value C_{MAX} (e.g., two) at step 232, the controller 180 builds a retry message at step 234 and transmits the retry message at step 236. For example, the processor constructs a retry message (as shown in FIG. 5D) with a header (as shown in FIG. 6) at step 234 by setting the operation ID to that of a “go to preset” command, including the appropriate preset in the data payload, and including an ACK bitmap having the bits set corresponding to the processors from which acknowledgement messages were expected but not received. The controller 180 also sets the message type to a command message, and sets the ACK requirement flag and the retry flag. The transmitting procedure 200 then loops to wait for the acknowledgement messages at step 216 or the timeout to expire at step 218.

If the No_ACK counters of the processors from which acknowledgement messages were not received are not less than the maximum counter value C_{MAX} at step 232, the controller 180 removes the individual PROC addresses of the processors from which acknowledgement messages were not received from the processor list in the memory 182 and clears the No_ACK counters at step 238. Finally, the controller 180 increments the sequence number at step 224 and the transmitting procedure 200 loops around to wait for the next digital message to transmit at step 210.

If the message time period T_{MSG} expires at step 212 before the controller 180 has a digital message to transmit at step 210, the controller builds a data message at step 240 and transmits the data message on the interprocessor link 130 at step 242. The controller 180 may construct the data message (as shown in FIG. 5A) at step 240 by setting the message type of the header to that of a data message, not setting either the acknowledgement requirement flag or the retry flag of the header, and including, for example, a present light intensity of a connected lighting load in the data payload. Therefore, each processor 120A-124C is guaranteed to transmit a digital message on the interprocessor link 130 at least every 30 seconds.

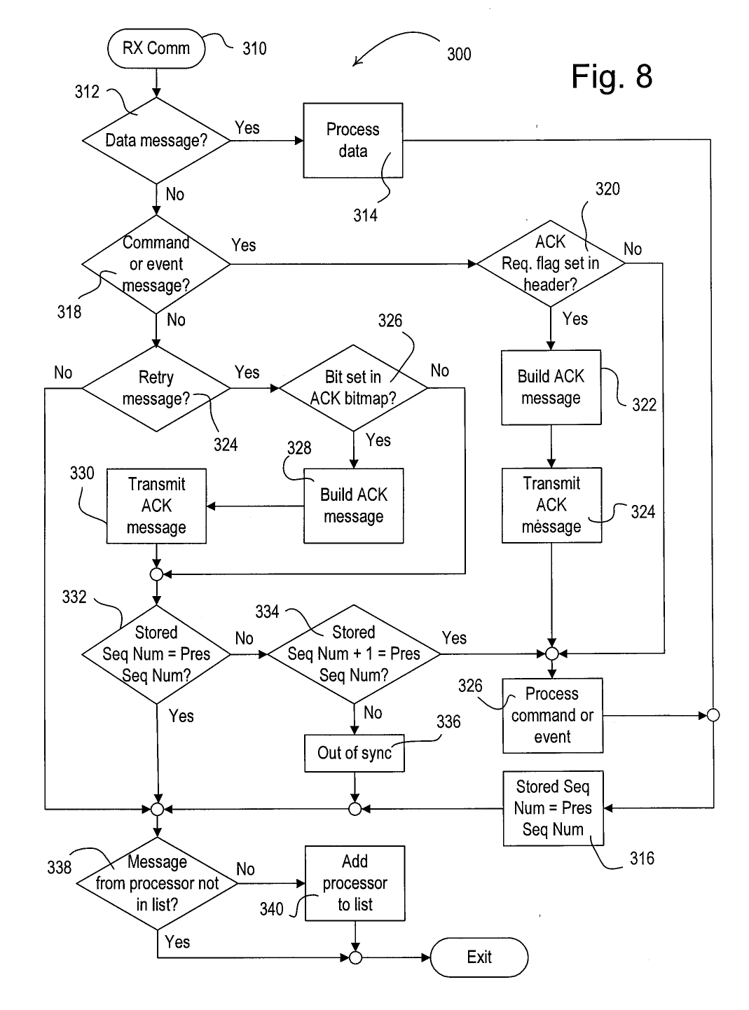

FIG. 8 is a simplified flowchart of a receiving procedure 300, which is executed by the controller 180 of each processor 120A-124C when a digital message is received at step 310. If the received digital message is a data message at step 312, the controller 180 processes the received data appropriately at step 314. The controller 180 stores the sequence number of the last digital message received from the each of the processors to determine if the processor has missed any digital messages that were transmitted on the interprocessor link 130. At step 316, the controller 180 updates the stored sequence number for the processor from which the digital message was received at step 310 with the present sequence number from the received digital message. If the controller 180 determines at step 338 that the received digital message is from a processor of which the individual PROC address is not in the processor list, the controller add the individual PROC address of the newly-found processor to the processor list at step 340. Finally, the receiving procedure 300 exits.

If the received digital message is not a data message at step 312 but is a command or event message at step 318 and the ACK requirement flag is set in the header of the received digital message at step 320, the controller 180 builds an acknowledgement message at step 322 and transmits the acknowledgement message at step 324. For example, if the controller 180 receives a digital message having a “go to preset” command, the controller builds an acknowledgement message comprising simply a header (as shown in FIG. 5B) with the message type set as an acknowledgement message, the target PROC address set as the sender PROC address of the received digital message, and the sequence number set as the sequence number of the received digital message. However, if the digital message is a “request for data” command and the requested data can be quickly retrieved from the memory 182, the controller 180 constructs an acknowledgement with data message (as shown in FIG. 5C) with the requested data as the data payload. The controller 180 appropriately processes the command or event of the received digital message at step 326 and updates the stored sequence number at step 316. If the controller 180 determines at step 338 that the received digital message is from a processor of which the individual PROC address is not in the processor list, the controller add the individual PROC address of the newly-found processor to the processor list at step 340, before the receiving procedure 300 exits.

If the received digital message is not a data message at step 318, but is a retry message at step 324, a determination is made at step 326 as to whether the appropriate bit for the receiving processor is set in the ACK bitmap of the retry message. If so, the controller 180 builds an appropriate acknowledgement message at step 328 and transmits the acknowledgement message at step 330.

If the stored sequence number for the processor from which the digital message was received (i.e., as stored in the memory 182) is equal to the present sequence number from the received digital message at step 332, the controller 180 has already received and processed the digital message. Accordingly, the receiving procedure 300 simply exits. If the present sequence number from the received digital message is not equal to the stored sequence number at step 332, but is equal to one more than the stored sequence number at step 334, the controller 180 determines that the last digital message was missed. Thus, the controller 180 processes the command or event from the received retry message at step 326 and updates the stored sequence number at step 316. However, if the present sequence number is equal to the stored sequence number at step 332 or one more than the stored sequence number at step 334, then a conclusion is made at step 336 that the controller 180 is out of sync with the communications of the interprocessor link 130. If the controller 180 determines at step 338 that the received digital message is from a processor of which the individual PROC address is not in the processor list, the controller add the individual PROC address of the newly-found processor to the processor list at step 340. Finally, the receiving procedure 300 exits.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A load control system for controlling the amount of power delivered to a plurality of electrical loads, the load control system comprising:
a plurality of control devices each characterized by a unique individual address, a subset of the control devices characterized by an identical multicast address; and
a communication link coupled to each of the plurality of control devices;
wherein each of the control devices are operable to transmit an initial digital message having a target address on the communication link, re-transmit the initial digital message on the communication link only if the target address of the initial digital message is equal to the multicast address, and transmit an acknowledgement message in response to receiving the initial digital message;
wherein each control device is operable to determine if acknowledgement messages are received from each of the control devices from which acknowledgement messages are expected during a predetermined amount of time after transmitting the initial digital message, the control devices further operable to transmit a retry message in response to determining that the acknowledgement messages were not received from each of the control devices from which acknowledgement messages were expected during the predetermined amount of time.

2. The load control system of claim 1, wherein the retry message comprises the initial digital message along with data representative of the control devices from which the acknowledgement messages were not received.

3. The load control system of claim 2, wherein the data representative of the control devices from which the acknowledgement messages were not received comprises a bitmap having bits set to represent the control devices from which the acknowledgement messages were not received.

4. The load control system of claim 3, wherein a specific control device is operable to transmit an acknowledgement message in response to determining that the bit representing the specific control devices is set in the bitmap of the retry message.

5. The load control system of claim 1, wherein the communication link comprises an Ethernet link.

6. The load control system of claim 1, wherein each of the control devices comprises a managed switch to provide filtering of the digital messages based upon the target address of the digital messages.

7. The load control system of claim 6, wherein the managed switch of each of the control devices is operable to store the multicast address, and re-transmits a specific digital message on the communication link if the target address of the specific digital message is equal to the multicast address.

8. The load control system of claim 1, wherein each control device maintains a list of the individual addresses of a subset of the control devices in the load control system, such that each control device is operable to determine if acknowledgement messages are received from each of the subset of the control devices having an individual address included in the list of individual addresses during the predetermined amount of time after transmitting an initial digital message.

9. The load control system of claim 1, wherein the control devices comprise processors coupled to a plurality of load control devices for controlling the amount of power delivered to the plurality of electrical loads.

10. The load control system of claim 1, further comprising:
an application server coupled to the communication link and comprising a visual display, the application server operable to display information on the visual display in response to digital message received via the communication link.

11. A method of communicating a digital message in a load control system having a plurality of control devices coupled together via a communication link, each of the control devices characterized by a unique individual address, a subset of the control devices characterized by an identical multicast address, the plurality of control devices including first, second, and third control devices, the method comprising the steps of:
the first control device maintaining a list of the individual addresses of each of the control devices on the communication link;
the first control device transmitting an initial digital message on the communication link, the initial digital message including a target address;
the second control device receiving the initial digital message;
the second control device re-transmitting the initial digital message on the communication link if the target address of the initial digital message is equal to the multicast address of the control devices;
the second control device transmitting an acknowledgement message to the first control device in response to receiving the initial digital message;
the first control device waiting for a predetermined amount of time after the first control device transmitted the initial digital message to receive an acknowledgement message from the second and third control devices;
the first control device determining that an acknowledgment message was not received from the third control device; and
the first control device transmitting a first retry message after the end of the predetermined amount of time in response to determining that the first control device did not receive the acknowledgement message from the third control, the first retry message comprising the initial digital message.

12. The method of claim 11, wherein the first retry message comprises the initial digital message along with data representative of the control devices from which the first control device did not receive an acknowledgement message.

13. The method of claim 12, wherein the data representative of the control devices from which the first control device did not receive an acknowledgement message comprises a bitmap having bits set to represent the control devices from which the first control device did not receive an acknowledgement message.

14. The method of claim 13, further comprising the steps of:
the third control device determining that a bit representing the third control device is set in the bitmap of the first retry message; and
the third control device subsequently transmitting the acknowledgement message to the first control device.

15. The method of claim 11, further comprising the steps of:
the first control device transmitting a plurality of retry messages, each of the retry messages comprising the initial digital message;
the first control device determining that no acknowledgment messages were received from the third control device in response to the plurality of retry messages; and
the first control device removing the individual address of the third control device from the list of individual addresses.

16. The method of claim 11, further comprising the steps of:
the first control device receiving a digital message from a fourth control device, the digital message including an individual address of the fourth control device; and
the first control device subsequently adding the individual address of the fourth control device to the list of individual addresses of the control devices.

17. The method of claim 11, wherein the acknowledgement message transmitted by the second control device comprises a unique individual address of the first control device.

18. A load control system for controlling the amount of power delivered to a plurality of electrical loads, the load control system comprising:
a plurality of sub-systems;
a plurality of processors included in each of the sub-systems;
an interprocessor link coupling together the processors, such that each of the processors is operable to transmit an initial digital message to all of the processors of a specific sub-system;
wherein each of the processors is operable to transmit an acknowledgement message in response to receiving the initial digital message, each processor further operable to determine if acknowledgement messages are received from each of the processors from which acknowledgements messages were expected during a predetermined amount of time after transmitting the initial digital message, and transmit a retry message in response to determining that the acknowledgement messages were not received from each of the processors from which acknowledgements messages were expected during the predetermined amount of time.

19. A processor for a load control system having a plurality of processors coupled together via a communication link, each of the processors characterized by a unique individual address, a subset of the processors characterized by an identical multicast address, the processor comprising:
a managed Ethernet switch adapted to be coupled to the communication link, the managed Ethernet switch operable to store the multicast address and re-transmit a received digital message on the communication link if a target address of the received digital message is equal to the multicast address;
a controller coupled to the managed Ethernet switch, such that the controller is operable to transmit an initial digital message on the communication link, and receive a plurality of acknowledgement messages in response to the initial digital message;
a memory coupled to the controller for storing the individual addresses of at least one of the processors on the communication link;
wherein the controller is operable to determine if acknowledgement messages are received from each of the control devices having an individual address stored in the memory during a predetermined amount of time after transmitting the initial digital message, and transmit a retry message in response to determining that the acknowledgement messages were not received from each of the control devices having an individual address stored in the memory during the predetermined amount of time.

20. A method of communicating a digital message in a load control system having a plurality of control devices coupled together via a communication link, the method comprising the steps of:
transmitting an initial digital message on the communication link;
determining that an acknowledgment message was not received from at least one of the control devices in response to the initial digital message; and
transmitting a retry message in response to determining that the acknowledgement message was not received from the at least one of the control devices, the retry message comprising the initial digital message along with data representative of the at least one control device from which the acknowledgement message was not received.

21. The method of claim 20, wherein the data is representative of all of the control devices from which the acknowledgement messages were not received.

22. The method of claim 21, wherein the data representative of all of the control devices from which the acknowledgement messages were not received comprises a bitmap having multiple bits set to represent the control devices from which acknowledgement messages were not received.

23. The method of claim 20, wherein the data representative of the at least one control device from which the acknowledgement message was not received comprises a bitmap having a specific bit set to represent the at least one control device.

24. The method of claim 23, further comprising the steps of:
the at least one control device determining that the specific bit is set in the bitmap of the retry message; and
the at least one control device subsequently transmitting the acknowledgement message.

25. The method of claim 20, further comprising the step of:
maintaining a list of individual addresses of a subset of the control devices on the communication link, the list including the individual address of the at least one control device from which the acknowledgement message was not received.
